(19) United States
(12) Patent Application Publication
(10) Pub. No.: US 2008/0274327 A1
(43) Pub. Date: Nov. 6, 2008

(54) ALDIMINES OR KETIMINES FOR IMPROVED ADHESION OF UV CLEARS

(75) Inventors: Roy E. Dean, Lower Burrell, PA (US); Robert T. Pogue, Pittsburgh, PA (US)

Correspondence Address: PPG INDUSTRIES INC;INTELLECTUAL PROPERTY DEPT, ONE PPG PLACE, PITTSBURGH, PA, 15272, US

(73) Assignee: PPG INDUSTRIES OHIO, INC., Cleveland, OH (US)

(21) Appl. No.: 11/744,452

(22) Filed: May 4, 2007

(51) Int. Cl. B32B 21/08; C08F 118/02; C08G 63/91

(52) U.S. Cl. 428/98; 106/163.01; 106/287.26; 106/34; 525/410; 528/271; 528/332

(57) ABSTRACT

A coating system for application to a porous substrate such as wood is disclosed. The coating system comprises a color-imparting stain or toner and a UV-curable clear coat. The stain and/or toner contains an aldimine or a ketimine that improves the adhesion of the coating system to the substrate.

### FIELD OF THE INVENTION

The present invention relates to a coating system for applying a multi-layer composite coating to a substrate such as wood and to the resultant coated substrate.

### BACKGROUND OF THE INVENTION

There are a number of considerations relevant in the art of protective and decorative coating systems for substrates, such as wood substrates, including cabinets, floors, furniture, and the like. Such coating systems are often made up of more than one coating layer. Porous substrates, such as wood, for example, are often coated with multi-layer composite coating systems that include a toner layer, a stain layer, a sealer layer, and a topcoat layer. Typically, the toner and/or stain layer(s) are coloring layers, i.e., they provide coloring. The sealer layer is often a protective layer that is sanded to provide a smooth finish, while the topcoat layer is often a protective layer that provides surface properties, such as mar and scratch resistance.

Radiation or UV-curable topcoats based on resins that are curable by exposure to ultraviolet radiation are well known in the art for wood coatings. Such resins provide coatings with excellent properties and are particularly desirable for wood finish applications because of the heat sensitivity of wood. UV curing occurs at room temperature, whereas many of the curable systems require heat for curing.

One disadvantage to UV-curable topcoats is adhesion to the underlying stains or toners that are used in wood coatings. These materials are not UV-curable and consequently adhesion of UV-cured topcoats to these materials often suffers. Consequently, it would be desirable to provide a coating system comprising a UV-curable clear coating composition for application over a colored stain or toner composition, which has good intercoat adhesion.

### SUMMARY OF THE INVENTION

The present invention provides a coating system for depositing a multi-layer composite coating on a substrate. The coating system comprises:

(a) a UV-curable clear coating composition for application over

(b) a coating composition containing a colorant.

Coating composition (b) also contains an aldimine or a ketimine resulting in improved adhesion compared to a similar coating system without the aldimine or ketimine.

The invention also provides for a substrate coated with the multi-layer coating composition described above.

### DETAILED DESCRIPTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. For example, and without limitation, this application refers to coating systems that comprise a colorant layer. Such references to “a colorant layer” is meant to encompass coating systems comprising one colorant layer as well as coating systems that comprise more than one colorant layer, such as coating systems that comprise two colorant layers. Colorants are ingredients that impart color to layers. Examples of colorants are dyes and pigments, both inorganic and organic. Inorganic pigments include metal oxides such as the oxides of iron, titanium, zinc, cobalt, and chrome. Earth colors may employ mineral pigments obtained from clay. Various forms of carbon may be used for black coloration. Organic pigments are typically derived from natural or synthetic materials, and include phthalocyanine, lithos, toluidine, and para red. Organic pigments may be employed in a precipitated form as a lake. Dyes encompass a wide variety of organic materials that may be used in stain compositions, e.g., acid dyes. In addition, in this application, the use of “or” means “and/or” unless specifically stated otherwise, even though “and/or” may be explicitly used in certain instances.

In certain embodiments, the present invention is directed to coating systems suitable for application over porous substrates, such as wood. As used herein, the term “porous substrate” refers to substrates that contain pores or interstices that allow a liquid composition to penetrate the surface of the substrate.

The liquid compositions that comprise the coating systems of the invention are coating compositions containing a colorant and a UV-curable clear coating composition. The coating compositions containing a colorant are referred to as stains and toners.

As used herein, the term “stain” refers to a translucent composition that can color a porous substrate, such as wood, while allowing some of the substrate's natural color and grain to show through. As used herein, the term “toner” refers to a composition that performs a function similar to a stain in that it can color a porous substrate, however, a “toner” is typically lower in solids content than a stain (no more than 5 weight percent solids and at least 95 weight percent solvent) and is typically applied to a substrate at a low film thickness before a stain is applied.

Besides colorants, both stains and toners comprise film-forming resins. As used herein, the term “film-forming resin” refers to resins that can form a continuous film on at least a horizontal surface of a substrate upon removal of any diluents or carriers present in the composition or curing.

The film-forming resin used in stains is not limited and may include, for example, any film-forming resin typically used in the art, such as polyurethanes, acrylics, vinyls, melamines, polyvinylchlorides, polyolefins, polyureas, polycarbonates, polyethers, polyesters including alkyd resins, epoxies, silicones, polyamides, cellulosic resins, and the like. For stain use, alkyd resins are sometimes preferred.

As used herein, the term “alkyd resin” denotes a synthetic resin that is the reaction product of a polybasic acid or anhydride, a polyhydric alcohol, and an oil fatty acid. Such resins are often prepared by polycondensation of various polybasic acids, polyhydric alcohols and fatty acids. As used herein, the term “oil fatty acid” includes, for example, drying oils, semi-drying oils, and non-drying oils, including mixtures thereof. As will be appreciated by those skilled in the art, when one or more drying oils, one or more semi-drying oils or mixtures of drying and semi-drying oils are used, the coating compositions of the present invention will be capable of undergoing oxidative cure. Similarly, if a mixture of at least one of the drying oils or the semi-drying oils with a non-drying oil is used, with the mixture being predominantly drying and/or semi-drying, the compositions will also undergo oxidative cure. “Predominantly drying” and/or “semi-drying” means that at least about 45 percent of the oils used are drying and/or semi-drying. Both drying and semi-drying oils contain carbon-carbon double bonds that are capable of undergoing oxidative crosslinking, whereas nondrying oils either don't contain such bonds or don't contain a sufficient number of such bonds to effect cure.

Examples of suitable drying and semi-drying oils include castor oil, dehydrated castor oil, cottonseed oil, fish oil, linseed oil, menhaden oil, oiticica oil, palm kernel oil, perilla oil, safflower oil, sardine oil, soybean oil, sunflower oil, tall oil, tung oil, and walnut oil. Examples of suitable non-drying oils include valeric acid, heptanoic acid, 2-ethyl hexanoic acid, pelargonic acid, isononanoic acid, lauric acid, coconut oil fatty acid, stearic acid and branched fatty acids containing 18 carbon atoms. Predominantly drying/semi-drying oils are often more appropriate for use in the present stains.

Suitable polyhydric alcohols that can be used in forming such alkyd resins include glycerol, neopentyl glycol, cyclohexanedimethanol, ethylene glycol, propylene glycol, pentaerythritol, neononyl glycol, diethylene glycol, dipropylene glycol, trimethylene glycol, trimethylolpropane, dipentaerythritol, tripentaerythritol, and the like.

Suitable polybasic acids/anhydrides that can be used in forming such alkyd resins include polycarboxylic acids and anhydrides thereof. Examples of suitable polycarboxylic acids include phthalic acid, isophthalic acid, terephthalic acid, tetrahydrophthalic acid, hexahydrophthalic acid, adipic acid, azelaic acid, glutaric acid, 3,3-diethylglutaric acid, malonic acid, pimelic acid, sebacic acid, suberic acid, succinic acid, 2,2-dimethylsuccinic acid, 2-methylsuccinic acid, dodecenylsuccinic acid, itaconic acid, fumaric acid, maleic acid, citraconic acid, diethyl maleic acid, and trimellitic acid; the anhydrides of those polybasic acids are also suitable. Polybasic acids having greater than three acid moieties or the higher polyfunctional alcohols should not be utilized in amounts that will cause the alkyd resin to gel during preparation.

For toner use, cellulosic resins are sometimes preferred. As used herein, the term “cellulosic resin” refers to the generally known thermoplastic polymers which are derivatives of cellulose, examples of which include: nitrocellulose; organic esters and mixed esters of cellulose such as cellulose acetate, cellulose propionate, cellulose butyrate, and cellulose acetate butyrate; and organic ethers of cellulose such as ethyl cellulose.

Stains typically comprise 0.25 up to 15 percent by weight of film-forming resin or, in some embodiments, 9 up to 15 percent by weight of film-forming resin based on the total weight of the composition. Colorants are typically present in stains in amounts of 5 up to 30 percent by weight, and, in some embodiments, from 7 up to 25 percent by weight, based on total weight of the composition.

Toners typically comprise 0.25 up to 5 percent by weight of film-forming resin or, in some embodiments, 0.5 up to 2 percent by weight of film-forming resin based on the total weight of the composition. Colorants are typically present in toners in amounts of 1 up to 5 percent by weight, and, in some embodiments, from 2 up to 5 percent by weight, based on total weight of the composition.

Besides film-forming resins and colorants, the stains and toners contain diluents. Suitable diluents include organic solvents, water, and/or water/organic solvent mixtures. Suitable organic solvents include, for example, alcohols, ketones, aromatic hydrocarbons, glycol ethers, esters or mixtures thereof. In certain embodiments, the diluent is present in the stain in an amount ranging from 10 to 70 weight percent based on total weight of the composition, such as 30 to 50 percent. In certain embodiments, the diluent is present in the toner in an amount ranging from 10 to 80 weight percent based on total weight of the composition, such as 40 to 60 weight percent.

The coating compositions containing a colorant as described above also contain an aldimine or a ketimine that are polyamines containing latent or blocked primary amine groups formed from reacting primary amines with an aldehyde or ketone to form an aldimine group or a ketimine group.

Examples of suitable polyamines are aliphatic, cycloaliphatic, aromatic, aralkyl and alkaryl polyamines. Examples include polyamines having 2 to 6 amine groups per molecule. Specific examples include ethylene diamine, propylene diamine, 1,6-hexanediamine and cycloaliphatic diamines of the formulas:

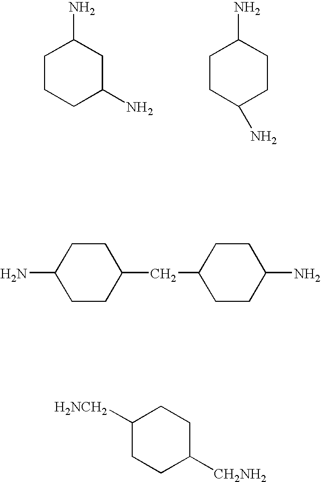

Also useful are polyamines containing three or more amine groups. Examples of such polyamines include diethylene triamine, triethylene tetraamine, and tris-(2-aminoethyl) amine.

Ketimines and aldimines can be obtained by reaction of a primary polyamine with an aldehyde or ketone to form a polyaldimine or a polyketimine. Examples of aldehydes and ketones suitable for use in making the aldimines and ketimines include those containing 1 to 8 carbon atoms such as propionaldehyde, butyraldehyde, isobutyraldehyde, acetone, methyl ethyl ketone, methyl isobutyl ketone, diisopropyl ketone, cyclopentanone and cyclohexanone.

The polyketimine may be a polymeric material. For example, a polymer obtained by reacting an NCO-prepolymer or an epoxy-functional polymer with a ketimine that contains a secondary amine group, for example, the diketimine of diethylene triamine.

The aldimine or ketimine is present in the coating composition typically in amounts of 0.1 to 25 percent by weight, more typically 0.5 to 10 percent by weight based on total weight of the coating composition.

In addition, the stains and toners can contain optional ingredients including fillers, plasticizers, flow control agents, surfactants and other known formulating additives. Also useful in the stains and toners is an aluminum or titanium chelating crosslinker, such as ALUSEC 510 ethyl acetoacetato-di-2-ethoxy aluminum manufactured by Manchem Ltd. or TYZOR TPT tetraisopropyl titanate manufactured by DuPont. In certain embodiments, an antiskin agent, such as methyl ethyl ketoxime may be added to, for example, improve package stability. In some cases, fillers and flatting agents, such as clay, talc, silica, and the like can be added. Suitable silicas are commercially available from W.R. Grace and Company as SYLOID 169 and from DeGussa Corporation as AEROSIL 972. Sag resistance additives, such as cellulose acetate butyrate 551-0.2 from Eastman Chemicals can also be included, as can other additives that enhance properties. Various additives, when used, typically comprise no more than 30 weight percent, such as no more than 10 weight percent, of the coating composition based on the total weight of the composition.

The stains and toners can be applied to any of a variety of substrates. In certain embodiments, however, the coating compositions are applied to a porous substrate, such as paper, cardboard, particle board, fiber board, wood, wood veneers, and wood products. Various woods that can be stained with the present compositions include, for example, oak, pine, and maple. These types of woods are used in the preparation of, for example, kitchen cabinets, bath cabinets, tables, desks, dressers, and other furniture, as well as flooring, such as hardwood and parquet flooring.

The stains and toners can be applied to the substrate by any means known in the art. For example, they can be applied by wiping, brushing, dipping, flow coating, roll coating and conventional and electrostatic spraying.

Once applied, certain embodiments of the stains and toners are allowed to soak into the porous substrate for a predetermined amount of time, and the excess stain wiped off. Multiple layers can be applied. When the coating composition comprises a wood stain comprising an alkyd resin, as described above, the stain can then be cured by oxidative cure accomplished by allowing the coated substrate to be exposed to ambient or elevated temperature conditions. For example, the ambient or elevated temperature conditions can be those generally considered to be “air dry” or “force dry” conditions. This occurs at temperatures ranging from about 13° C. to 250° C., such as 20° C. to 150° C., or 50° C. to 90° C. Oxidative cure in the absence of accelerating conditions can take place over the course of several days to several weeks.

As will be appreciated, particularly in the treatment of wood substrates, additional layers such as a sealer and/or a topcoat may be applied over the top of a stain and/or toner layer. Therefore, certain embodiments of the present invention are directed to substrates at least partially coated with a multi-layer composite coating system. As used herein, the term “multi-layer composite coating system” refers to coating system that contains at least two coating layers applied successively over a substrate.

These coating systems of the present invention comprise (i) a colorant layer deposited from any of the foregoing stains or toners and (ii) at least one of a sealer and topcoat deposited from a radiation curable composition, applied over at least a portion of the colorant layer. In certain embodiments, the coating systems of the present invention comprise (i) a toner layer deposited from any of the foregoing coating compositions of the present invention, (ii) a stain layer deposited from any of the foregoing coating compositions of the present invention, wherein the stain layer is deposited over at least a portion of the toner layer, (iii) a sealer deposited from a radiation curable composition, wherein the sealer is deposited over at least a portion of the stain layer and/or toner layer, and (iv) a topcoat deposited from a radiation curable composition, wherein the topcoat is deposited over at least a portion of the sealer. In certain embodiments, the radiation curable composition from which at least one of the sealer and topcoat is deposited comprises a 100% solids or waterborne composition.

As used herein, the term “sealer” refers to a clear protective coating applied directly to a colorant layer, such as a toner and/or stain, while a “topcoat” refers to a clear protective coating applied directly to the sealer or to the toner or stain. In the coating systems of the present invention, the sealer and/or topcoat are deposited from radiation curable compositions, such as compositions comprising a radiation curable material susceptible to cationic and/or free radical cure. For example, in certain embodiments the sealer and/or the topcoat are deposited from a composition comprising a polymer comprising an alkyd portion and a free radical curable portion, such as is described in United States Patent Application Publication No. 2004-0013895 A1 at [0005] to [0022], which is incorporated by reference herein.

In certain embodiments, an ultraviolet light source having a wavelength range of 180 to 4000 nanometers may be used to cure the sealer and/or topcoat compositions. For example, sunlight, mercury lamps, arc lamps, xenon lamps, gallium lamps, and the like may be used. In one example, the sealer and/or topcoat compositions may be cured by a medium pressure mercury lamp having an intensity of 48 to 360 W/cm, for a total exposure of 100 to 2000 mJ/cm², such as 500 to 1000 mJ/cm² as measured by a POWERMAP UV Radiometer commercially available from EIT Inc., Sterling, Va.

In certain embodiments of the present invention, the toner and/or stain is applied to the substrate. The stain and/or toner may or may not undergo oxidative cure before application of the sealer and/or topcoat (application of the sealer/topcoat to the uncured stain and/or toner will be understood by one skilled in the art as a “wet on wet” application). After the sealer and/or topcoat is applied, these layers are at least partially cured. While not being bound by any theory, it is believed that some radiation curable monomers present in the sealer/topcoat radiation curable compositions may migrate into the stain layer, the toner layer, and/or the porous substrate during application and prior to cure. The materials containing functional groups in the stain layer and/or the toner layer react with radiation-curable monomers resulting in improved interlayer adhesion. As indicated, however, the present invention is not limited to this mechanism. As a result, the multi-layer composite coatings of the present invention may offer desirable levels of adhesion, toughness, appearance, feel and/or stain/solvent resistance, among other properties. As used herein, the term “partial cure” refers to any stage of curing between complete cure and no cure.

In certain embodiments, the substrates of the present invention are coated with a multi-layer composite coating exhibiting a tape adhesion of at least 50%, with tape adhesion testing being performed according to ASTM D-359. In certain embodiments, such coatings exhibit a tape adhesion of at least 85% or, in some cases, 100%.

In certain embodiments, the substrates of the present invention are coated with a multi-layer composite coating exhibiting nickel scrape resistance of at least 8. Nickel scrape resistance is an evaluation of a coating system's resistance to gouge. As used herein, nickel scrape resistance is tested using five replicates on a single sample and with results reported in comparison to a control coating system. The test may be conducted using a United States Government 5 cent coin without obviously worn surfaces. The nickel is grasped between the thumb and forefinger and, using medium to firm pressure, the nickel edge is scraped over the coated surface. The pressure # required to gouge the coated surface is assigned a whole number from 1 to 15 with 1 being minimal effort and 15 being maximum effort.

Illustrating the invention are the following examples, which, however, are not to be considered as limiting the invention to their details. Unless otherwise indicated, all parts and percentages in the following examples, as well as throughout the specification, are by weight.

### EXAMPLES

Examples A and B show the preparation of various ketimines.

Examples 1, 2 and 3 show the application of a toner, sealer and topcoat (in that order) to wood substrates followed by adhesion testing. Examples 2 and 3 use toners modified with the ketimines of Examples A and B, respectively. Example 1 was a control with no ketimine modification.

Examples 4, 5 and 6 were similar to Examples 1, 2 and 3 but using a different sealer. Example 4 was the control.

Examples 7, 8 and 9 were similar to Examples 1, 2 and 3 but using a different topcoat. Example 7 was the control.

Examples 10,11 and 12 were similar to Examples 4, 5 and 7 but using a different topcoat. Example 10 was the control.

### Example A (HRM 8145 CAS 62286-43-5)

A polyketimine was prepared from the following reactants:

| Reactant | Moles |
|---|---|
| Isophorone diisocyanate | 2.87 |
| Polycaprolactone diol (Tone 0200) | 1 |
| Methyl isobutyl diketimine of diethylene triamine | 3.3 |

The isophorone diisocyanate was reacted with the polycaprolactone diol to form an NCO-prepolymer. The NCO-prepolymer was then capped with the diketimine.

### Example B (KA-11-8712; CAS 175021)

A polyketimine was prepared from the following reactants:

| Reactant | Equivalent |
|---|---|
| Epoxy novalac resin available from | 1 (epoxy) |
| Huntsman as ARALDITE EPN 1139 | |
| Methyl isobutyl diketimine of diethylene | 1 (secondary amine) |
| triamine | |

The epoxy novalac resin was reacted with the diketimine.

### Example 1 (Control)

Maple veneer substrates were sanded with 200 grit sandpaper. A cognac toner (C1692E-33 from PPG Industries) was applied to the substrate using a single pass Devilbiss Model MSA handheld spray gun using 30 psi air pressure (207 kilopascals) to achieve a uniform layer with excess toner being removed by rag wiping. The toner coating was given a one (1) minute flash at ambient conditions followed by the application of a cognac stain (C1419E31 from PPG Industries). The stain was applied in the same manner to achieve a uniform layer with excess stain being removed by rag wiping. The stain was given a sixteen (16) minute flash at ambient conditions and a two (2) minute bake at 180° F. (82° C.). After cooling to ambient temperature, a sealer composition (R 1834 Z49 from PPG Industries) was preheated to 130° F. (54° C.) and was then spray applied using a Devilbiss Model JGA handheld spray gun using 60 psi pressure (414 kilopascals) to achieve a wet film thickness of about 0.5 mil (1 2.7 micrometers). The sealer coat was then given an ultra-violet (UV) light exposure of 700 mJ/cm². The coated veneer was allowed to cool to ambient temperature, sanded with 280 grit sandpaper followed by the spray application as described immediately above of a UV-curable topcoat composition (R1707Z83 from PPG Industries), preheated to 130° F. (54° C.) to achieve a wet film thickness of 0.7 mil (17.8 micrometers). The topcoat was then given a UV exposure of 850 mJ/cm² to cure the topcoat. Adhesion of the composite coating to the substrate was evaluated as reported in Table 1 infra.

### Example 2

Example 1 was repeated with the exception that the toner was modified with two percent (2%) by weight of the polyketimine of Example A; the percentage being based on total toner weight.

### Example 3

Example 1 was repeated with the exception that the toner was modified with two percent (2%) by weight of the polyketimine of Example B; the percentage being based on total toner weight.

### Example 4 (Control)

Example 1 was repeated with the exception that the sealer R1834Z49 was modified with ten percent (10%) by weight of the diglycidyl ether of bisphenol A; the percentage being based on total sealer weight.

### Example 5

Example 4 was repeated with the exception that the toner was modified with two percent (2%) by weight of the polyketimine of Example A; the percentage being based on total toner weight.

### Example 6

Example 4 was repeated with the exception that the toner was modified with two percent (2%) by weight of the polyketimine of Example B; the percentage being based on total toner weight.

### Example 7 (Control)

Example 1 was repeated with the exception that a water-based topcoat (A1392Z83 from PPG Industries) replaced the topcoat used in Example 1. The water-based topcoat was spray applied with a Binks Model 2000 handheld sprayer at 60 psi (207 kilopascals) pressure to achieve a wet film thickness of 5 mils (12.7 micrometers). The topcoat was then dried for eight (8) minutes at 150° F. (66° C.) and given a UV exposure of 850 mJ/cm².

### Example 8

Example 7 was repeated with the exception that the toner was modified with two percent (2%) by weight of the polyketimine of Example A; the percentage being based on total toner weight.

### Example 9

Example 7 was repeated with the exception that the toner was modified with two percent (2%) by weight of the polyketimine of Example B; the percentage being based on total toner weight.

### Example 10 (Control)

Example 7 was repeated with the exception that the sealer (R1834Z49) was modified with ten percent (10%) by weight of the diglycidyl ether of bisphenol A; the percentage being based on total sealer weight.

Example 11

Example 10 was repeated with the exception that the toner was modified with two percent (2%) by weight of the polyketimine of Example A; the percentage being based on total toner weight.

Example 12

Example 10 was repeated with the exception that the toner was modified with two percent (2%) by weight of the polyketimine of Example B; the percentage being based on total toner weight.

After application and curing of the topcoats, the veneers were maintained at ambient temperature overnight and tested for adhesion as described below. The results are reported in Table 1.

TABLE 1

| Example No. | Tape Adhesion¹ | Scrape Adhesion² |
|---|---|---|
| 1 | 2B | 2 |
| 2 | 3B | 6 |
| 3 | 5B | 10 |
| 4 | 3B | 3 |
| 5 | 4B | 7 |
| 6 | 5B | 15 |
| 7 | 2B | 4 |
| 8 | 3B | 8 |
| 9 | 5B | 15 |
| 10 | 3B | 5 |
| 11 | 4B | 10 |
| 12 | 5B | 15 |

¹Performed using 3M Scotch Masking Tape 250 3005, with performance rated on the following scale: 5B = 100% adhesion; 4B = 99%–95% adhesion; 3B = 85%–94% adhesion; 2B = 65%–84% adhesion; 1B = 35%–64% adhesion; 0B = 0%–34% adhesion.
²Nickel scrape adhesion is a quantitative evaluation of a coating system's resistance to gouge. Nickel scrape was tested using several replicates on a single sample and with results reported in comparison to a control coating system. The test was conducted using a United States Government 5 cent coin without obviously worn surfaces. The nickel was grasped between the thumb and forefinger and, using medium to firm pressure, the nickel edge was scraped over the coated surface.The pressure # required to gouge the coated surface was assigned a whole number from 1 to 15 with 1 being minimal effort and 15 being maximum effort.

Whereas particular embodiments of this invention have been described above for purposes of illustration, it will be evident to those skilled in the art that numerous variations of the details of the present invention may be made without departing from the invention as defined in the appended claims.

We claimed:

1. A coating system for depositing multi-layer composite coatings to a porous substrate comprising:
(a) a UV-curable clear coating composition for application over a
(b) coating composition containing a colorant wherein coating composition (b) contains an aldimine or a ketimine.

2. The coating system of claim 1 in which the UV-curable composition is a poly(meth)acrylate.

3. The coating system of claim 2 in which the poly(meth)acrylate is a polyurethane poly(meth)acrylate.

4. The coating system of claim 2 in which the poly(meth)acrylate is derived from a polyepoxide.

5. The coating system of claim 1 in which the coating composition (b) contains a film-forming resinous binder selected from an alkyd resin and a cellulosic resin.

6. The coating system of claim 1 in which the coating composition contains a ketimine.

7. The coating system of claim 6 in which the ketimine is a polyketimine.

8. The coating system of claim 7 in which the polyketimine is a polymeric material.

9. In a substrate coated with a multi-layer composite coating system wherein the multi-layer composite coating system comprises:
(a) a colorant layer deposited from a coating composition containing a colorant,
(b) a clear coat deposited from a UV-curable clear coating composition deposited over the colorant layer wherein the coating composition containing the colorant also contains an aldimine or a ketimine.

10. The substrate of claim 9 being a porous substrate.

11. The substrate of claim 9 being wood.

12. The substrate of claim 9 in which the colorant layer is derived from a toner composition.

13. The substrate of claim 9 in which the colorant layer is derived from a stain composition.

14. The substrate of claim 9 in which the clear coat is derived from a sealer composition.

15. The substrate of claim 9 in which the clear coat is derived from a topcoat composition.

16. The substrate of claim 9 in which the UV-curable clear coating composition is a poly(meth)acrylate.

17. The substrate of claim 16 in which the poly(meth)acrylate is a polyurethane poly(meth)acrylate.

18. The substrate of claim 16 in which the poly(meth)acrylate is derived from a polyepoxide.

19. The substrate of claim 9 in which the colorant layer contains a film-forming resinous binder selected from an alkyd resin and a cellulosic resin.

20. The substrate of claim 9 in which the coating composition contains a ketimine.

21. The substrate of claim 20 in which the ketimine is a polyketimine.

22. The substrate of claim 21 in which the polyketimine is a polymeric material.

23. In a porous substrate coated with a multi-layer composite coating system wherein the multi-layer composite coating system comprises:
(a) a layer comprising a toner composition deposited on the porous substrate,
(b) a layer comprising a stain composition deposited on (a),
(c) a layer comprising a UV-curable sealer composition deposited on (b), and
(d) a layer comprising a UV-curable topcoat composition deposited on (c);
wherein at least one of the layers (a) or (b) is deposited from a composition containing an aldimine or a ketimine.

24. The porous substrate of claim 23 being wood.

25. The porous substrate of claim 23 in which the composition contains a ketimine.

26. The porous substrate of claim 25 in which the ketimine is a polyketimine.

27. The porous substrate of claim 26 in which the polyketimine is a polymeric material.
